(19) United States
(12) Patent Application Publication
(10) Pub. No.: US 2019/0291831 A1
(43) Pub. Date: Sep. 26, 2019

(54) Hazardous Condition Alert and Electric Isolation Apparatus for Marinas and Docks

(71) Applicants: Kyle Larson, Camdenton, MO (US); Travis Bockoven, Camdenton, MO (US); Travis Higginbotham, Linn Creek, MO (US)

(72) Inventors: Kyle Larson, Camdenton, MO (US); Travis Bockoven, Camdenton, MO (US); Travis Higginbotham, Linn Creek, MO (US)

(21) Appl. No.: 16/362,073

(22) Filed: Mar. 22, 2019

Related U.S. Application Data
(63) Continuation of application No. 62/761,495, filed on Mar. 26, 2018.

(51) Int. Cl. B63B 45/08; G08B 21/18; G08B 21/02

(52) U.S. Cl. CPC B63B 45/08; B63B 2201/26; G08B 21/02; G08B 21/185

(57) ABSTRACT

A safety apparatus designed to prevent electric shock and protect equipment on or around marinas or docks. Said apparatus alerts and electrically isolates the marina or dock from the power source in the event a hazardous condition is detected. Safety hazards include, but are not limited to: Earth-ground fault, electricity in the water, high-water condition, or dock-break away condition. Comparing to prior art, the distinction of said invention is providing personal and equipment protection from all hazardous scenarios, and a fail-safe operation.

### CROSS-REFERENCE TO RELATED APPLICATIONS

This application claims priority from provisional application 62/761,495, titled Safe Smart Dock, and filed Mar. 3, 2018.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

Electric Shock Drowning (ESD) is a silent killer of swimmers near docks with 120 VAC. According to the Centers for Disease Control and Prevention (CDC), “Drowning accounts for approximately 4200 deaths each year in the United States.” Unfortunately, no federal systems are in place to subcategorize the causes of drowning, but there are a significant number of documented ESD deaths dated back to 1999. KOLR ESD can be caused by multiple factors.

A very small amount of current from a 120 VAC circuit can cause ESD. It takes as little as 5 ma of current to cause muscle paralysis, and 100 ma to cause heart fibrillation. Both can easily cause death while swimming. Current can enter the water or the frame of the dock when a ground fault occurs from a faulty electrical component, or faulty wiring. Other possible instances causing electricity in the water are flooding situations, or dock-shore breakaway situations. These instances are especially dangerous for emergency personnel responding to the situation. Electric shock occurs when the human body is contacted between the voltage source and ground. The human body has resistance (ohms), which provides a medium for the current to flow through. According to the National Institute for Occupational Safety and Health, the human body's resistance can range from 10,000 ohms to 500 ohms dependent upon conditions of the skin and body. Using ohm's law (Voltage=current×Resistance), a potentially dangerous voltage can occur with as little as 3 VAC. Many recreational lakes have low conductivity, which means the resistance of the water is generally higher than the resistance of a human body. The result of that fact is electricity flows better through the human body as opposed to a body of water. It is very important to do everything possible to minimize the risk of ESD. The current solutions of preventing ESD don't completely eliminate the risk of swimming or working near docks or marinas with electrical power.

According to the Electric Shock Drowning Prevention Association (ESDPA), the only sure way to prevent ESD is to abstain from swimming within 150 feet of a dock with 120 VAC. On many recreational lakes, this wouldn't be a solution that dock owners and tourists were satisfied with. A major reason to visit a recreational lake is to be able swim and have stress free fun.

The next best solution provided by the ESDPA is to have your dock wired per NFPA 70 and NFPA 303 specifications. Following these specifications ensures that the dock is properly wired and grounded, and that the proper components are used. Also, it is necessary have your dock regularly inspected by a certified electrician to ensure all GFCI outlets, breakers, and wiring are intact and functioning properly. Unfortunately, we can't prevent electrical components from failing, and we can't predict exactly when those components will fail. Mike Holt, a NEC trainer and consultant, states that, “According to a 1999 study by the American Society of Home Inspectors, 21% of GFCI circuit breakers and 19% of GFCI receptacles inspected didn't provide protection, leaving the energized circuit unprotected.” If a GFCI outlet or breaker fails, it may not trip the circuit when a ground fault occurs. This will cause voltage on the dock and equipment connected to ground. The electrical equipment and wiring of a dock experience stress daily. Exposure to the elements, storms, constant movement, and other factors may cause the ground connection to either become an open circuit or to have a high resistance. If this occurs, the current will find an easier path to Earth ground, such as through a swim ladder or human body into the water. Another safety concern presented by using GFCI breakers is the fact that they only interrupt the ungrounded line conductor. After that particular circuit is interrupted, it would still be possible for the neutral conductor to have voltage and carry current. The neutral conductor will have a potential voltage to ground (N-G voltage) in normal conditions. In normal operating conditions, on a properly wired system, there will be a 3V N-G voltage. That number could increase significantly with an improperly wired system, corrosion of conductors, the use of certain motors, or failure of components. Due to the fact that the neutral conductor is bonded to Earth ground, and the fact that a dock is bonded to the Earth ground, abnormally high voltages on the neutral conductor will be present on the dock frame and other metal equipment. Even a fault on a neighboring houses neutral conductor can feed through the utility lines to the dock. Furthermore, if flooding occurs, non-watertight conduit or equipment could expose live circuits to the water. Even the presence of voltage as little as 3 VAC in water or a dock frame can cause a dangerous current to a person swimming in water. This fact shows the necessity for a requirement to interrupt the neutral conductor to a dock as well as the ungrounded line conductor.

It is also necessary to break the Earth ground conductor from the house or utility pole to prevent this same situation. According to Ameren UE, there have been situations where a ground fault inside a house didn't trip the breaker, due to improperly wired or ground systems. This caused a voltage to be present on the metal swim ladder of the dock. According to Ameren UE, in 2017, an Earth-ground fault located inside an outlet box at the house exposed a dangerous voltage on the frame of the dock, and caused a fatality when a women attempted to climb out of the water using the ladder. Although the solution of following NFPA 70 and NFPA 303 is necessary, it doesn't completely eliminate the risk of ESD.

There are multiple supplemental solutions, which help aid in the detection of electricity in the water. These devices signal an audible and visual alarm when electricity is present in the water. These devices implement many different layout variations of electrodes or sensor probes connected to voltmeters, ammeters, or signal processors to determine if a dangerous amount of electricity is present in the water. The ESDPA refers to these products as ‘green light devices’. “These alarm systems create a false sense of safety when used as a ‘swimming green light’ and are of serious to concern to the ESDPA.” These alarm devices are reactive in nature; not predictive.” There is no way to predict exactly when or where a fault will occur. The association strongly disapproves the use of green light devices as an indicator that it is safe to swim; although, they do support using the devices to alert the dock owner of an electrical fault. Green light devices have the potential to be improved upon to become a necessary safety device on docks with electrical power.

### FIELD OF THE INVENTION

This invention pertains to the following classes:
1. A signaling device responding to abnormal conditions of a body of water and surrounding equipment (G08B21/08).
2. Emergency protective circuit arrangements for automatic disconnection directly responsive to an undesired change from normal electric working condition with or without subsequent reconnection; integrated protection responsive to difference between voltages or between currents (H02H3/26).

### SUMMARY OF THE INVENTION

The purpose of the described invention is a safety and equipment protection device for marinas and boat docks utilizing electric power. The apparatus detects various types of hazardous conditions, visually and audibly alerts as a hazard is detected, and isolates the electric power to the dock or marina from the source. Electric shock drowning (ESD) may occur around docks and marinas due to ground faults, stray voltages, and equipment failure causing dangerous voltages to be present on exposed dock frames and equipment.

The current solutions don't protect from every possible situation. The solutions provided by NFPA 303 and NFPA 70 rely on properly grounded systems and ground fault circuit interrupters (GFCI). Grounding systems and GFCI's can fail at any time due to environmental factors, improperly installed systems, and equipment lifespans. Furthermore, a GFCI doesn't protect against ground faults sourced from a separate circuit.

There are also supplemental solutions referred to as ‘green light devices.’ These devices audibly and visually alert when electricity is detected in the water. These devices are reactive, and only alert if a fault is present. This doesn't provide protection from faults that occur while a person is on or around a dock or marina. Furthermore, these devices don't provide any protection in the event of device failure.

The described apparatus of this invention is an all-encompassing safety and equipment protection device. The apparatus detects multiple safety and equipment hazards: Earth-ground fault, electricity in the water, high-water condition, dock-shore breakaway, etc. When any hazard is detected, the apparatus audibly and visually alerts, and electrically isolates the dock or marina from the power source by breaking all current carrying conductors, including the Earth ground conductor. This eliminates all sources of a hazardous condition. Furthermore, the apparatus is designed with safety redundancy. If any component or wiring of the system fails, the apparatus will default to the electrical isolation state to achieve a fail-safe operation.

The objective of the described invention is to provide protection for persons and equipment around docks and marinas from every possible electrical hazard scenario.

### BRIEF DESCRIPTION OF DRAWINGS

FIG. 1 is a block diagram portraying the overall flow of components in the described invention;

FIG. 2 is a schematic diagram of the components and circuitry required to achieve the claimed operation;

FIG. 3 is an overhead view of an installed apparatus described in the invention; and

FIG. 4 is a representation of the preferred embodiment of the control box described in the invention.

### DETAILED DESCRIPTION OF THE INVENTION

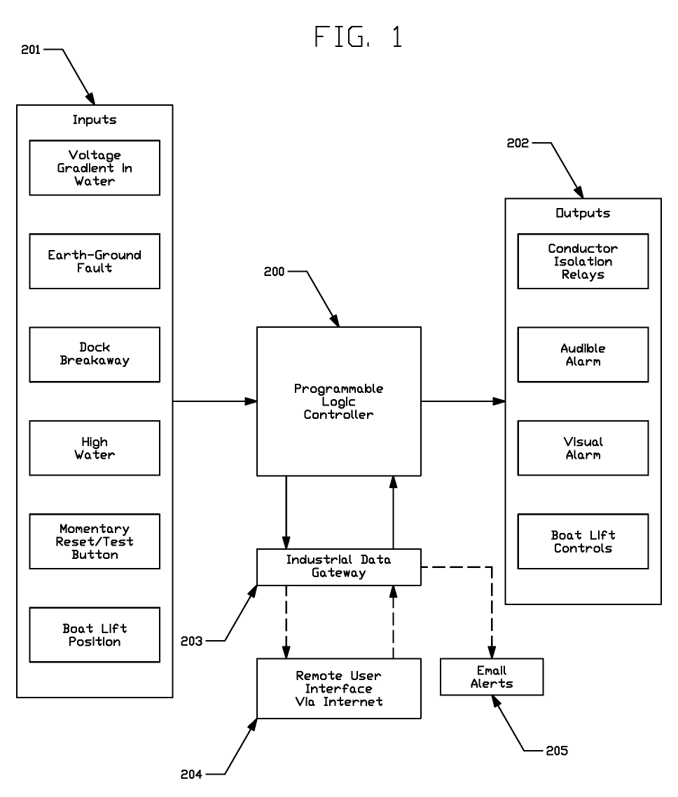

The overall flow of the apparatus is portrayed in FIG. 1, and will generally remain constant even in deviations from the preferred embodiment described below. Programmable logic controller (PLC) 200 is the ‘brain’ of the apparatus. PLC 200 receives signals from inputs 201. These include all hazard sensors and the momentary reset and test button. Hazard sensors include, but are not limited to: electricity in the water, Earth-ground fault, dock-shore breakaway condition, and high-water condition. Another input 201 example is a sensor to determine the position of the boat lift. PLC 200 uses input 201 signals in Boolean logic functions to control outputs 202. Outputs 202 include necessary safety components such as conductor isolation relays 305, audible alarm 303, and visual alarm 302. Outputs 202 may also include convenient features such as boat lift controls, lighting controls, and stereo controls.

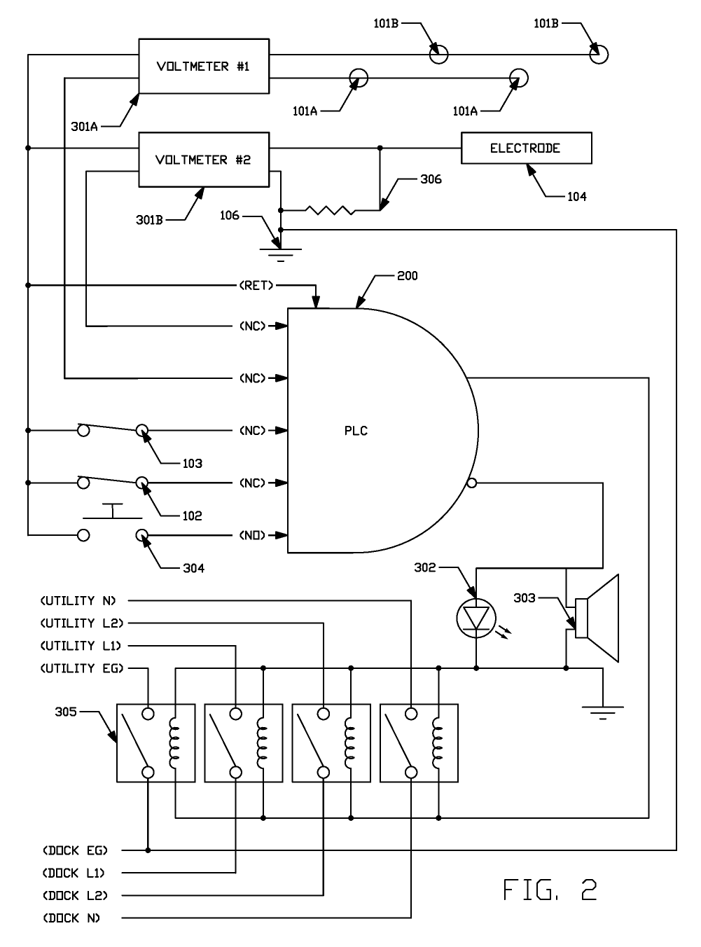

The circuitry and components required for achieving an all-encompassing and redundant safety system for marinas and boat docks is displayed in FIG. 2. The simplified Boolean logic function of PLC 200 is an AND gate. All equipment safety sensors are inputs of the AND gate function. The equipment safety sensors are wired as normally closed circuits when no fault is occurring. If any of the equipment safety sensor circuits becomes open, the AND gate deactivates. When the AND gate is activated, the output of PLC 200 is triggering the conductor isolation relays 305 to turn on. The conductor isolation relays 305 are connected in series of all conductors, including the Earth ground conductor, from the power source. Conductor isolation relays 305 are normally open circuit devices. In the event of PLC 200 failure, wiring failure, or any relay 305 failure, this ensures a fail-safe operation. Visual alarm 302 and audible alarm 303 are activated by a NOT state of the output of PLC 200 AND gate. When a hazardous condition occurs, and the AND gate is deactivated, the alarms will be triggered. In order to reactivate the AND gate, after a fault occurs, all hazard sensor circuits must return to the closed state, and reset button 304 must be momentarily depressed. The use of reset button 304 is necessary to prevent looping fault occurrences. With no reset button 304, this could happen when a fault is removed by the isolation circuit, and then reoccurs after the power automatically restores. The other function of momentary button 304 is a test button. By means of PLC 200 programming, the AND gate is deactivated when the momentary button 304 is depressed for five seconds or more. This action allows the user to test functionality of the conductor isolation relays 305 and the alarms without having to create an actual fault.

FIG. 1 also shows PLC 200 communicating with the industrial data gateway 203 via a serial connection. Industrial data gateway 203 runs a human machine interface (HMI) 204. The HMI 204 is a graphical interface (GI) displaying input 201 states, and output 202 control functions. PLC 200 reports input 201 states to the industrial data gateway 203, which then sends the data via an internet connection to the HMI 204. When an output control function of the HMI 204 is used, it sends the data to industrial data gateway 203 via internet connection. Industrial data gateway 203 then communicates the output control function to the PLC 200 via serial connection. The industrial data gateway 203 also alerts a marina or boat dock operator via email 205 when a safety hazard has occurred.

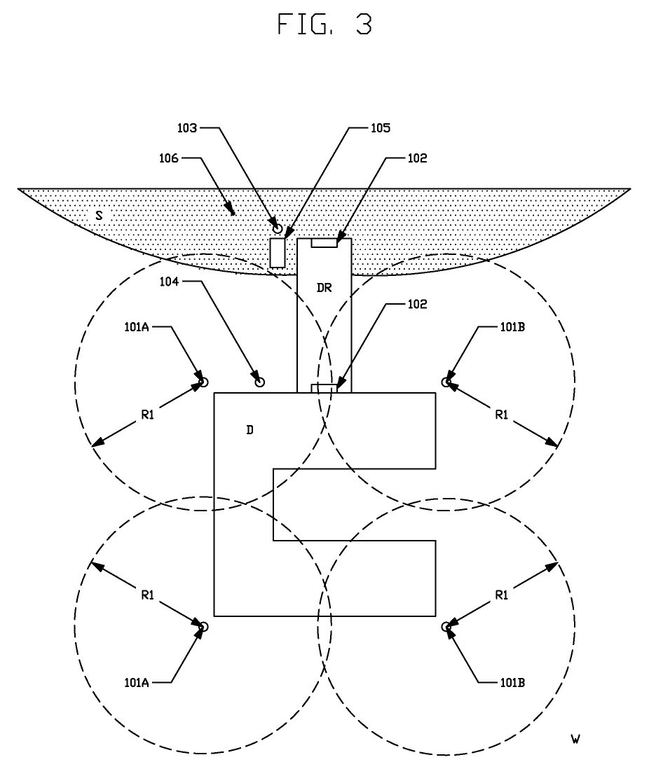

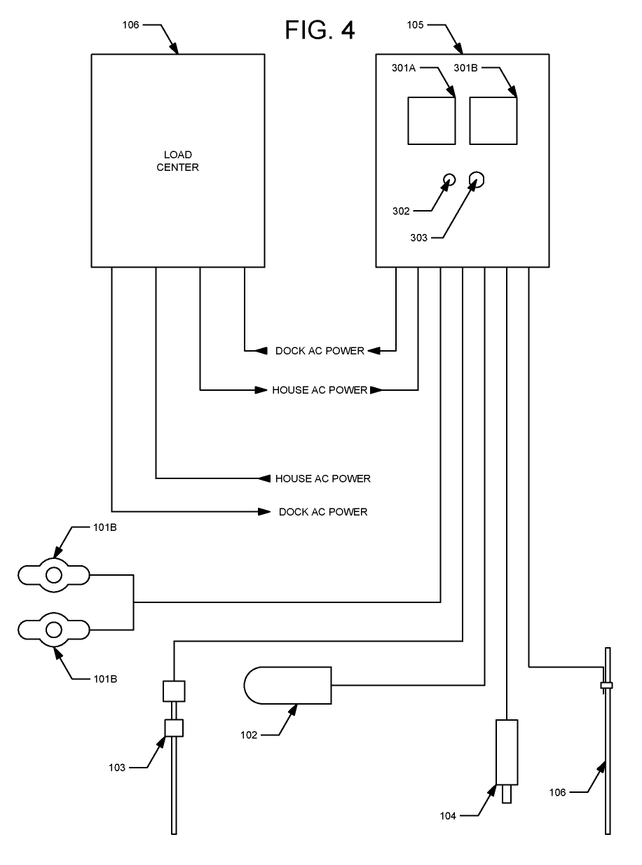

FIG. 3 portrays a diagram of an overhead view of an installed apparatus. Actual installations will vary dependent upon multiple factors such as dock size, dock location, and conductivity of the water. The preferred embodiment of a standard apparatus install is described. D represents the dock or marina. S refers to the shore in which D is attached. DR represents the dock ramp, which connects D to S. W, refers to the body of water that D is floating on. Control box 105 is located on S, and is a watertight enclosure housing all environmentally sensitive electronics such as PLC 200, industrial data gateway 203, voltmeters 301A,B, conductor isolation relays 305, shunt resistor 306, momentary reset and test button 304, and necessary power supply and circuit protection components. The preferred embodiment of control box 105 is portrayed in FIG. 4. The preferred embodiment shows visual alarm 302 and audible alarm 303 located on the face of control box 105, but the two alarms could also be located on D. Utility conductors from the power source are routed out of dock breaker box 106, and into control box 105 to receive protection from the conductor isolation relays 305. The protected conductors are then routed from control box 105 back into dock breaker box 106 before being routed out to D. Earth-ground rod 106 is located adjacent to control box 105. In the event of the conductor isolation relays 305 isolating D from the power source, Earth-ground rod 106 remains connected to D to continue providing ground fault protection and lightning protection for all equipment.

Float sensor 103 is one of the hazard sensors. It is located on or near S, and placed level with the electrical datum plane. The construction of float sensor 103 must be heavy-duty to be able to handle harsh conditions. In the event of a high-water condition, the circuit state of float sensor 103 changes from normally closed to open. This signals PLC 200 that a high-water condition has occurred. The circuit is wired normally closed to provide redundancy in the event of sensor failure, or wiring failure. This function protects dock workers and first responders responding to an emergency situation.

FIG. 3 also depicts two dock-shore breakaway sensors 102. The dock-shore breakaway sensor 102 is a heavy-duty reed switch. These switches 102 are placed at every moveable joint. Typically, there will be one placed between D and DR, and one placed between DR and S. In the event any joint becomes separated, the corresponding switch circuit state changes from normally closed to open. This signals PLC 200 that a dock-shore breakaway condition has occurred. The circuit is wired normally closed, and all switches 102 are wired in series to provide redundancy in the event of switch failure, or wiring failure. This function protects dock workers and first responders responding to an emergency situation.

The next component depicted in FIG. 3 is the reference electrode 104. It may be of the water or soil variety. The depicted example shows reference electrode 104 placed in W. Reference electrode 104 is used to detect the most common safety hazard, an Earth ground fault. Reference electrode 104 provides a reference point for voltmeter 301B to measure the Earth-ground circuit. This is a common knowledge method used in both marine and plumbing applications to detect corrosion causing stray voltages. Due to floating voltages on the Earth-ground circuit from the utility lines, shunt resistor 306 is connected between reference electrode 104 and the Earth-ground circuit to prevent false fault readings. As seen in FIG. 2, voltmeter 301B positive input is connected to Earth-ground side of shunt resistor 306, and voltmeter 301B negative input is connected to the reference electrode 104 side of shunt resistor 306. The resistance value of shunt resistor 306 is chosen to resemble the resistance of a human body when immersed in water. That value is 500 ohms. The dangerous current threshold of a Class B GFCI device is 6ma. Using that current value, and the resistance value of shunt resistor 306, in ohm's law (voltage=current×resistance), the dangerous voltage threshold is calculated to be 3V. When 3V is measured by voltmeter 301B, alarm output circuit state of voltmeter 301B is changed from normally closed to open. This signals PLC 200 that an Earth-ground fault has occurred. The alarm output circuit is wired normally closed to provide redundancy in the event of voltmeter 301B failure, or wiring failure.

The final components depicted in FIG. 3 are the electricity in the water probes 101A and 101B. The two sets of probes are insulated conductors with the ends exposed and permanently fixed in W. Probes 101A are connected to voltmeter 301A positive input, and probes 101B are connected to voltmeter 301A negative input. When a gradient voltage of 100 mV or more is measured by voltmeter 301A, alarm output circuit state of voltmeter 301A is changed from normally closed to open. This signals PLC 200 that electricity in the water has been detected. The alarm output circuit is wired normally closed to provide redundancy in the event of voltmeter 301A failure, or wiring failure. The measurement of gradient voltages to detect stray voltages is a common knowledge method used for corrosion prevention and livestock protection. Every conductor within a probe set, 101A or 101B, is wired in parallel with the other conductors of that set. The amount of conductors per set is determined by the size of the dock and the detection radius R1 of each probe. Radius R1 is a variable distance dependent upon the conductivity of the water. A sufficient amount of probes are installed to create a safety perimeter around the dock. Most lakes and rivers have low conductivity, so the ability to add probes is crucial to achieve full protection for different setups of D.

Thus, having described this new invention, what is claimed is:

1. An apparatus, for marinas and docks, to alert and electrically isolate said marina or dock from the power source in the event a hazardous condition is detected, said apparatus comprising:
hazard sensors including, but not limited to:
Earth-ground fault, electricity in the water, high-water condition, and dock-shore breakaway;
means of isolating all conductors, including the Earth-ground, to said marina or dock from the power source;
a momentary button to reset the system in the event of a hazardous condition, and to test the operation of the system;
a visual and audible alarm to alert nearby persons around said marina or dock that a hazard has occurred;
a logic controller to process system inputs, and control outputs using Boolean logic functions; and
a human machine interface (HMI) to remotely monitor and control said apparatus.

2. The apparatus of claim 1 wherein the means of detecting an Earth-ground fault is accomplished by using a voltmeter to measure voltage across a shunt resistor placed between the Earth-ground conductor and a reference electrode, and said voltmeter outputs a signal when the measured voltage exceeds the danger threshold.

3. The apparatus of claim 1 wherein the means of detecting electricity in the water is accomplished by using a voltmeter to measure a voltage gradient between two sets of insulated conductors;
the end of each conductor is exposed, and placed in a body of water at a distance, dependent upon the conductivity of the water, away from an opposing conductor; and
when a gradient voltage is measured, said voltmeter outputs a signal.

4. The apparatus of claim 1 wherein the means of detecting a high-water condition is accomplished by placing a float sensor at the electrical datum plane.

5. The apparatus of claim I wherein the means of detecting a dock-shore breakaway condition is accomplished by placing reed switches at every joint of the marina or dock walkway.

6. The apparatus of claim 1 wherein all hazardous condition sensors are wired as normally closed (N/C) circuits to the logic controller to achieve a fail-safe operation in the event of sensor or wiring failure.

7. The apparatus of claim 1 wherein the means of isolating all conductors to the marina or dock from the power source is accomplished by installing components capable of electrically breaking each conductor before the marina or dock (e.g., solenoids, relays, contactors, or shunt trip breakers) when any hazardous condition is detected.

8. The means of claim 7 wherein the isolation components' contactor circuits are normally open (N/O) to achieve a fail-safe operation in the event of component, equipment, or wiring failure.

9. The means of claim 7 wherein isolating the Earth-ground conductor from the power source excludes isolating the Earth-ground conductor to the marina or dock from the Earth-ground rod located adjacent to the marina or dock.

10. The apparatus of claim 1 wherein the remote human machine interface (HMI) is accomplished by an industrial data gateway communicating via internet, and serially linked to the logic controller.

11. The HMI of claim 10 comprised a graphical interface (GI) displaying real-time hazardous condition sensor states, and controllable output functions.
